(19) United States
(12) Patent Application Publication
(10) Pub. No.: US 2005/0108921 A1
(43) Pub. Date: May 26, 2005

(54) Structure of container

(76) Inventor: Hui-Ling Chen, Taipei (TW)

Correspondence Address: BACON & THOMAS, PLLC, 625 SLATERS LANE, FOURTH FLOOR, ALEXANDRIA, VA, 22314, US

(21) Appl. No.: 10/982,928

(22) Filed: Nov. 8, 2004

(30) Foreign Application Priority Data
Nov. 21, 2003 (TW) 092220694

(51) Int. Cl. A01M 1/00

(52) U.S. Cl. 43/132.1

(57) ABSTRACT

The present invention is a structure of container, which includes a protective cover and a body with a concave part. The said body has a first room formed between its outer edge and side-wall structure; the said protective cover is a hollow ring form with a second room provided at its cross section. The said protective cover and the said body are fitted in with each other and can be pressed for closing. When liquid is loaded into the first or the second room, the liquid will prevent the invasion of bugs or ants. Besides, even if the body is turned around 360 degrees, no leakage will happen because the liquid just flow between the first room and the second room.

### BACKGROUND OF THE INVENTION

1) Field of the Invention

The present invention is a structure of container. Specifically, it is a container with the outer edge covered with a hollow ring formed protective cover and liquid can be loaded in between the body and the protective cover to prevent the invasion of bugs and ants.

2) Description of the Prior Art

There are miscellaneous containers available commercially, such as cups, bowls, plates, basins, pots, and cans. All of these containers can not isolate themselves from ants' intrusion. The bugs or ants are apt to be attracted when food or sweet stuff is put inside the container, which not only is unsanitary and commonly causes disease but also aggravates the rottening of food.

To ameliorate the deficiency of conventional container, the inventor has referred to related prior arts presented in the patent publications, and investigated commercially available product worldwide. The functions and structures of conventional anti-bugs containers are thus generalized as follows.

Most of the prior arts isolate bugs by putting disinfestant at the base or filling water into the base. However, for these conventional arts, the water or disinfestant may flow to the floor once the base is canted or overturned. Differently, another prior art radiates electric wave from the base while the container storing food is put on the base to prevent the invasion of bugs.

The prior arts described above complicate the structural design of the base. For the manufacturer, many sets of mold are needed and assembly cost is increased. Consequently, the consumers not only should spend more money to buy but also have to spend more time to clean and maintain the base.

### SUMMARY OF THE INVENTION

The main object of this invention is to provide a container, in which the structure is simple yet distinct, such that putting a protective cover on the container body can we achieve the object of bugs prevention. The cost is thus decreased and it is easy to disassemble for scouring.

Another object of this invention is to provide a container, in which the container body and the protective cover are respectively provided with a room, while the rooms can be loaded with liquid to prevent the intrusion of bugs and ants. Further, even if the body is turned around 360 degrees, the liquid between the body and the protective cover will not leak.

When the body is put at a normal direction, the liquid will stay inside the room of protective cover. Food can be stored inside the body and is thus kept away from the intrusion of bugs and ants. On the other hand, when the body is put upside down (the bottom of the body is upturned), the liquid flow into the room of the body because of gravity, the food or other container can then be put on the bottom to keep away from the intrusion of bugs and ants, Therefore, the container of this invention works well either at normal direction or at upside-down direction. Furthermore, even the body of this invention is canted by 90 degrees, no leakage will happen because the liquid will stay between the room of body and the room of protective cover.

To further demonstrate the features, objects, and effectiveness of the present invention, the preferred and other embodiments together with the accompanying drawings are described in the following.

### BRIEF DESCRIPTION OF THE DRAWINGS

FIG. 1 is an exploded view of a preferred embodiment according to the present invention.

FIG. 2 is a sectional view of a preferred embodiment according to the present invention.

FIG. 3 is a sectional view showing the assembly of a preferred embodiment according to the present invention (at normal direction).

FIG. 4 is a sectional view showing the assembly of a preferred embodiment according to the present invention (at upside-down direction).

FIG. 5 is an exploded view of another embodiment according to the present invention.

FIG. 6 is a sectional view showing the assembly of another embodiment according to the present invention (at normal direction).

FIG. 7 is a sectional view showing the assembly of another embodiment according to the present invention (at upside-down direction).

### DETAILED DESCRIPTION OF THE PREFERRED EMBODIMENT

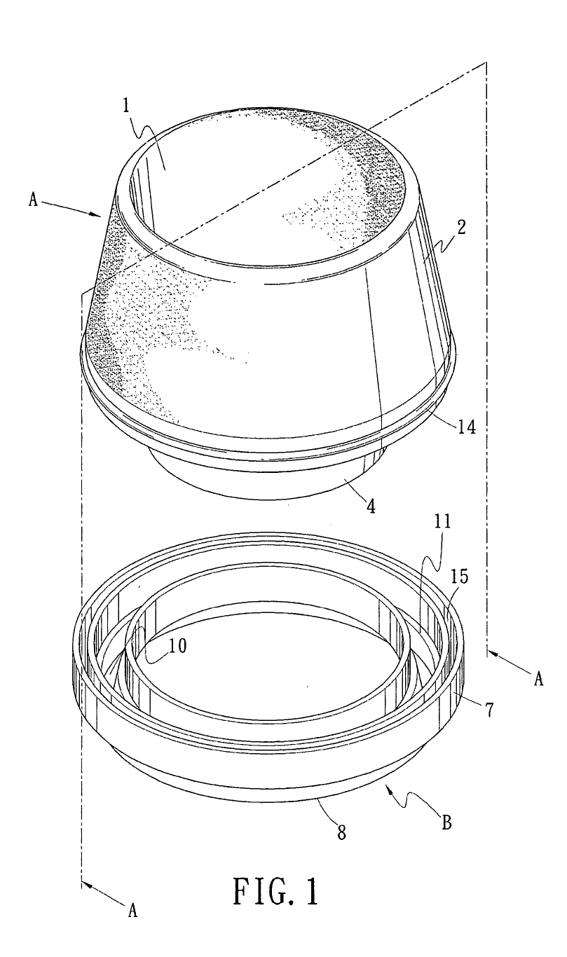

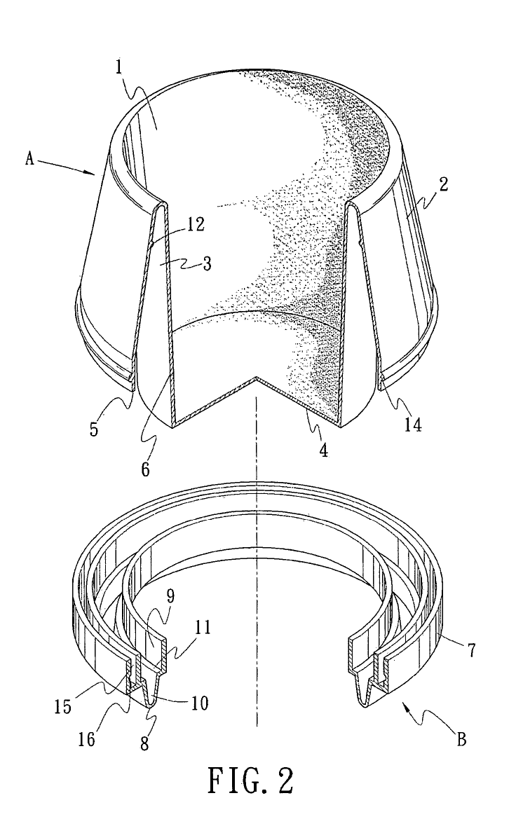

Firstly, referring to FIG. 1 and FIG. 2, the container of a preferred embodiment according to this invention mainly includes a body A and a protective cover B, which are separable. The body A is provided to store food or sweet stuff and keep them from the intrusion of bugs and ants. The body can be a cup, a bowl, a plate, a basin, a pot, or a can, with circular shape, polygon shape, or even irregular shape. The shape of protective cover B should match to the shape of body A in order to fit in with the body A. The protective cover B can accommodate adequate amount of liquid (e.g., water) and provide a function analogous to a fosse such that the bugs or ants are kept away from the food or sweet stuff stored in the container.

The body A further includes: a bottom 4, a side wall 6 extending upwards from the circular edge of bottom 4, a reflexed outer edge structure 2, and concave part 1 formed by the bottom 4 and side wall 6. The reflexed outer edge structure 2 extends a certain distance from the outer edge of side wall 6 towards the bottom 4, and thus forms a first room 3 between the outer edge structure 2 and the side wall 6. The outer edge structure 2 at the body A provides a ring flange 5, and a convex ring 14 can be further installed on the ring flange 5. The structure for fitting includes a ring slot 15 and a ring concave 16 which is located inside the ring slot 15. The width of ring slot 15 is roughly equal to the thickness of ring flange 5 in order to hold ring flange 5, and the location of ring concave 16 should match to the convex ring 14 in order to provide the functions of embedding and locating. Thus, the body A will not be separated from the protective cover B when they are assembled through the fitting structure.

The features of this invention include the structure of protective cover B as well as the ant-proof, 360 degree leak-proof, and the dual functions of normal direction and upside-down direction when the body A is fitted in with the protective cover B. The protective cover B is a hollow ring form, which includes: a cover outer wall 7, a cover inner wall 9, a cover bottom 8, and the second room 10 formed by the cover bottom 8, cover inner wall 7, and cover outer wall 9. The cover bottom 8 is slightly higher than the body bottom 4 and the cover inner wall 9 and the side wall 6 of body is separated by a certain distance 13 in order to avoid ants and bugs invading into body A through the protective cover B. Further, at the cover outer wall 7, fitting structure is provided to embed and locate the outer edge structure 2 of body A.

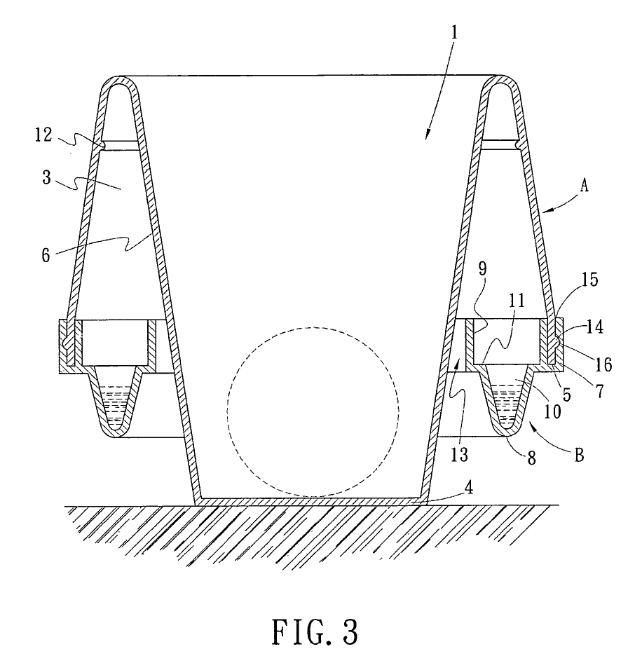

Referring FIG. 3, when the body A is put at its normal direction, i.e., the bottom 4 of body faces downwards, the second room 10 of protective cover B can be loaded with liquid (e.g., water) to prevent ants or bugs invading the food or sweet stuff stored at the concave part 1 of body A (as shown in the dotted line of FIG. 3). The structure described above can be embodied as a garbage bin to prevent the invasion of ants, cockroaches, or bugs when garbage is collected.

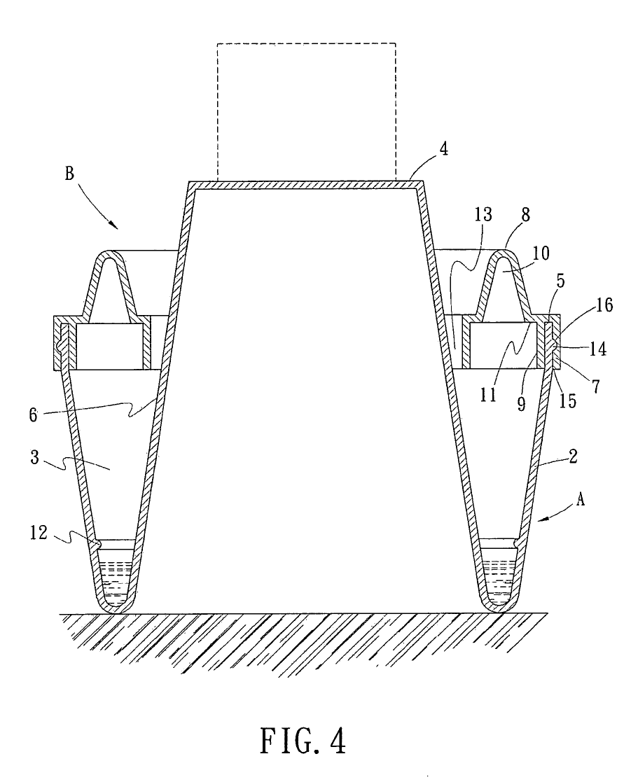

On the other hand, when the body A is put upside-down, i.e., the bottom of body 4 faces upwards, as shown in FIG. 4, the first room 3 of body A can be loaded with liquid (e.g., water) to prevent ants or bugs invading the upper area of bottom 4. Meanwhile, the user can store food or sweet stuff or other container storing food (or sweet stuff) to avoid the intrusion of ants and bugs (as shown in the dashed line of FIG. 4).

Therefore, as demonstrated in FIG. 3 and FIG. 4, with liquid being loaded into either the first room 3 or the second room 10, when the direction of body A is changed, the liquid will flow from one room to the other room because of gravity, and no leakage will happen. Consequently, the structure of container according to this invention features that, either being put at the normal direction or at the direction of upside-down, the container can prevent the invasion of bugs and ants as well. Furthermore, according to this invention, to tilt the body A by 90 degrees or even to turn around 360 degrees, the liquid will stay between the room 3 of body A and the room 10 of the protective cover B, leakage is completely prevented.

In the preferred embodiment, the structure around the second room 10 of protective cover B (e.g., the area including cover outer wall 7, cover inner wall 9, cover bottom 8) or even the whole protective cover B can be made of transparent material such that the user can inspect the amount of liquid from outside and decide whether there is enough liquid for isolating ants and bugs.

At the first room 3 of body A and the second room 10 of protective cover B, a body full level mark 12 and a cover full level mark 11 are respectively provided to indicate that the liquid is full loaded. No leakage will happen if the level of loaded liquid goes under the full level mark 12, 11, in spite of the body A being put at normal direction, upside-down direction, or tilted by 90 degrees.

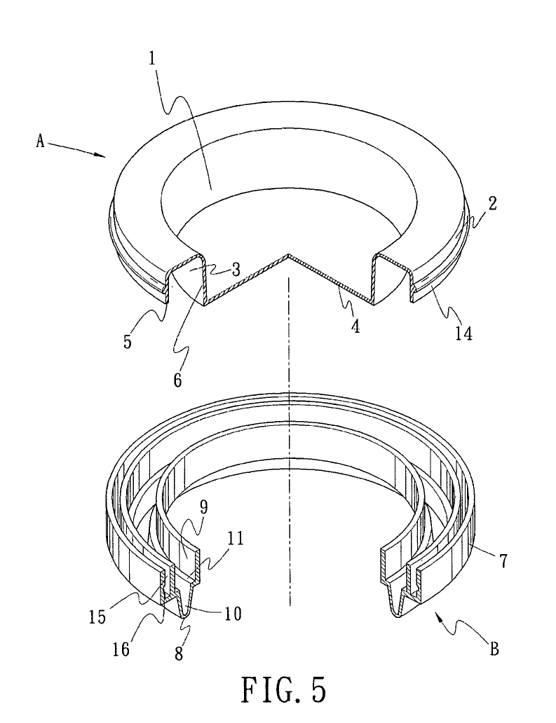

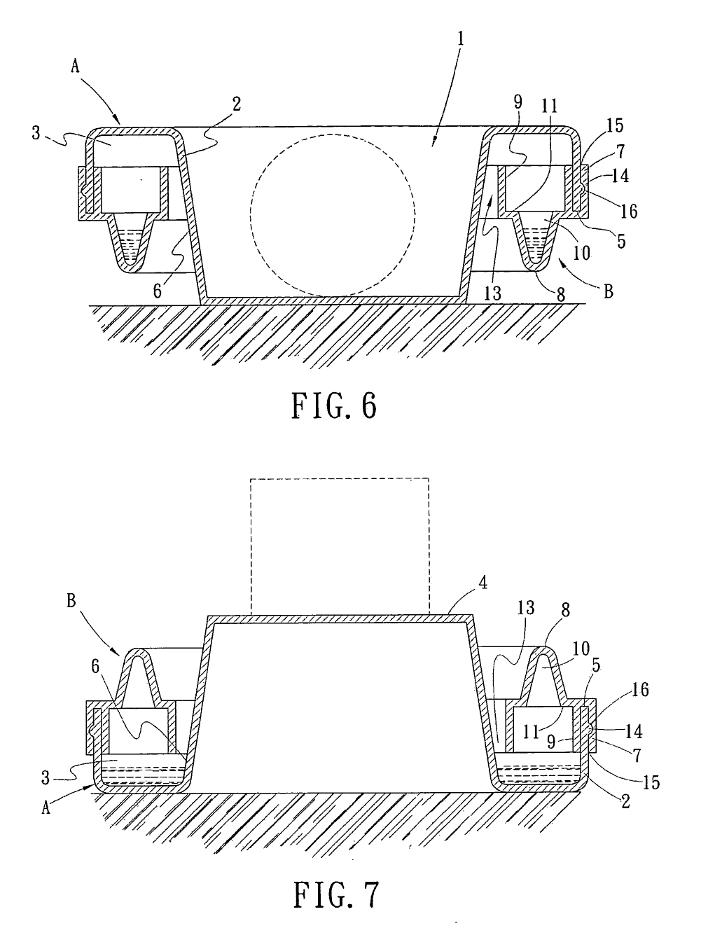

Referring FIG. 5, which is another embodiment according to this invention, in which the concave part 1 of body A is embodied into a swallow one in order to serve as a tableware (e.g., a plate or a dish). For the embodiment as shown in FIG. 6, when the body A is put at normal direction, i.e., the bottom of body 4 faces downwards, the second room 10 of protective cover B makes it possible to load minor amount of water to isolate the stored food from ants and bugs. Contrarily, when the body A is put upside down, i.e., the bottom of body 4 faces upwards, as shown in FIG. 7, the liquid will be kept to stay between two rooms 3, 10 of body A and protective cover B completely, no leakage will happen, and food as well as the sweetmeat can be stored at the area of the bottom 4 of body A.

1. A structure of container, which includes a body and a protective cover, where the body and the protective cover can be mutually lidded and joined;
the said body includes a bottom, a side wall which surrounds the said bottom, and a reflexed outer edge structure, the said bottom and the inside of side wall forms a concave part, the reflexed outer edge structure is reflexed at the circularly outer edge of the side wall and extends a certain distance towards the bottom, thus forms a first room between the outer edge structure and the side wall;
the said protective cover is a hollow ring form, which includes a cover outer wall, a cover inner wall, a cover bottom, and a second room formed by the cover outer wall, cover inner wall, and cover bottom;
the feature is: the cover outer wall is provided with a fitting structure to embed and locate the said outer edge structure, while the cover bottom is slightly higher than the body bottom, and the cover inner wall is separated from the body side wall by a certain distance.

2. A structure of container as claimed in claim 1, wherein at least the structure around the second room of protective cover is made of transparent material.

3. A structure of container as claimed in claim 1, wherein the fitting structure includes a ring slot and a concave ring which is located inside the ring slot, while the outer edge structure of body is further provided with a ring flange and a convex ring which is located on the ring flange, in which the width of the ring slot is roughly equal to the thickness of ring flange in order to hold the ring flange, and the convex ring matches convex ring in order to embed and fit each other; also the first room of body and the second room of protective cover are respectively provided with a body full level mark and a cover full level mark, in order to indicate the upper bound of loaded liquid.
